(19) United States
(12) Patent Application Publication
(10) Pub. No.: US 2010/0115506 A1
(43) Pub. Date: May 6, 2010

(54) METHOD AND ARRANGEMENT FOR SOFTWARE DEPENDENCY RESOLUTION

(76) Inventor: Rune Ljungbjörn, Goteborg (SE)

Correspondence Address: SCHWEGMAN, LUNDBERG & WOESSNER, P.A., P.O. BOX 2938, MINNEAPOLIS, MN, 55402, US

(21) Appl. No.: 12/518,255

(22) PCT Filed: Dec. 10, 2007
(86) PCT No.: PCT/SE07/50970

§ 371 Date: Dec. 28, 2009

Related U.S. Application Data
(60) Provisional application No. 60/869,550, filed on Dec. 11, 2006.

(30) Foreign Application Priority Data
Dec. 11, 2006 (SE) 0602671-0

(51) Int. Cl. G06F 9/445

(52) U.S. Cl. 717/174

(57) ABSTRACT

The present invention relates to a method and a computer arrangement comprising a processor and a memory. The processor is operatively arranged to execute a group of instructions present in the memory unit, and by means of interaction with other hardware arranged to access data organized into named files. The invention is characterized by resolution of dependencies on resources represented by said data in form of named files by configuration of said instruction group so that such dependencies are resolved from a specific set of file names, which has the property that all names, used in that set of file names for the purpose of said resource reference, correspond to the same contents of referenced objects, on all computers connected to said set of file names in the corresponding primary standard way.

### RELATED APPLICATIONS

This application is a nationalization under 35 U.S.C. 371 of PCT/SE2007/050970, filed Dec. 10, 2007 and published as WO 2008/073044 A2 on Jun. 19, 2008 which claimed priority under U.S.C. 119 to Sweden Application No. 0602671-0, filed Dec. 11, 2006 and which claimed priority under U.S.C. 119(e) to U.S. Provisional Patent Application No. 60/869,550, filed Dec. 11, 2006, which applications and publication are incorporated herein by reference and made a part hereof.

### THE TECHNICAL AREA OF THE INVENTION

The present invention relates to a method and a computer arrangement for configuration of a set of coded instructions for execution on computers or similar apparatus containing a processor with access to data organized into named files.

### BACKGROUND

Computer programs (software) are developed in practice mostly on computers other than those which are to run the computer program. This creates a need for delivery of software to the target computers. A common case is delivery to many independent consumers, i.e. computers managed by independent parties.

Traditionally, software is placed individually for each computer (usually on its local disk).

Each software unit usually presents certain requirements on other software resources which must be available. Examples of those are shared libraries, programs, data-files with graphic elements or word lists etcetera.

The above implies that each computer's configuration must be adjusted to each software to be run on it. This adjustment is usually done by copying software files to the computer and making changes in certain configuration files, repeating the process for all software units involved. This causes many decisions to be made and work to be done by the computer's administrator.

The most advanced and popular solution devised for making software administration easier have been the so called packaging systems.

Such systems let a computer administrator choose which applications (of the set available through the given packaging system) shall be copied to the computer and then the system resolves the interdependencies by copying in any necessary extra software units.

Each instance of a packaging system (e.g. Apt) together with packaged software is normally tightly coupled to a certain operating system kernel (e.g. Linux). Together, these are usually called “an operating system”, e.g. “Ubuntu Linux”.

Problems with this solution:
each computer must be administered with respect to the software;
the software selection is being decided per computer, not per user;
some applications or their versions can not coexist in the selection because of conflicting dependencies;
complete tests of software units and of their updates are almost impossible for the suppliers, because the combinations of software vary infinitely on different computers and the dependencies are being resolved in different ways.

Another popular solution for software delivery is so called web applications, where an application consists of two interacting parts, one on a remote server and the other on the terminal computer, using a web browser as run-time environment.

Problems with this solution:
the computer must have a web browser, which is a complicated piece of software itself, with many dependencies and maintenance needs (among others, security updates);
different web applications have different and sometimes conflicting demands on the web browser;
the performance is lower and the selection limited, compared to the traditional software.

Another known approach is the so called thin clients, which are remote terminals. They reduce administration as each computer (“server”) serves multiple users, but all the problems mentioned above remain in their entirety on the servers.

### SHORT DESCRIPTION OF THE EMBODIMENTS

The purpose of the present invention is to avoid or greatly reduce software-related administration of computers and/or corresponding apparatus.

For this purpose a method is provided to prepare a group of instructions (a program or a set of programs) for execution on a computer arrangement, and a system deploying this method is devised.

The method comprises resolution of a program's dependencies on resources represented by data in form of named files by configuration of said program so that a considerable and in practice the most important set of said dependencies (as defined in claim 1) is directed to be resolved from objects whose contents can be provided without administrative actions on the computer arrangement executing the program. For that purpose the names of said resource files are chosen to belong to certain parts of the total file name space provided by the operating system, the said parts being governed by special delivery mechanisms, said mechanisms implementing globality of the corresponding contents, i.e. that contents of file objects in said parts of said file name space is supposed to be identical on different computer arrangements without need for extra administrative actions, as long as the given computer arrangement is using the corresponding delivery mechanism in the for the said part of said file name space primary established and widely known way.

### SHORT DESCRIPTION OF THE DRAWINGS

The present invention will be described with reference to accompanying drawings, illustrating an exemplary embodiment of the invention, in which:

FIG. 1 is a block diagram of a system according to the invention, and

FIG. 2 is a flow diagram over the method according to the invention.

### DETAILED DESCRIPTION OF THE EMBODIMENTS

The invention will be described with reference to a non limiting embodiment, requiring construction and setup of the target computer, as follows:
1. A processor must be present implementing a certain instruction set, thus belonging to a class of compatible processors, whose class is chosen at the time of software configuration according to the invention.
   Examples: processor: AMD K-6; class: Intel x86-compatible 32-bit processors.

A computer program can be configured for multiple different processor classes at the same time, by applying the invention for each of the desired processor classes separately.
2. An operating system kernel must be loaded into memory, with certain program-to-kernel interface, thus belonging to a class of compatible kernels, whose class is chosen at the time of software configuration according to the invention.
   Examples: kernel: FreeBSD 5.0; class: Linux-2.4.19-compatible

A computer program can be configured for multiple different operating system kernel classes at the same time by applying the invention for each of the desired operating systems kernel classes separately.
3. A suitable set of file names (global file name space, referred to as GFNS below) must be made available via the operating system kernel chosen in step 2. Each name used for the purposes of the invention in that name space shall correspond to the same contents on all computers which access said GFNS according to the for said GFNS primary standard way, given access rights and accounting for possible delays of updates' spreading.
   One example of a suitable GFNS is the Distributed File Service (DFS) developed by Transarc Inc. and having been leveraged by IBM http://www.ibm.com/. DFS is available for multiple operating systems including Linux, Solaris from Sun Microsystems and Windows from Microsoft.
   DFS offers a global directory tree suitable for the purposes of the invention, under/ . . . (slash-dot-dot-dot) directory. The data in the directory tree is managed by dedicated servers. Every administrative unit possessing a domain name registered with the global domain name service (DNS) also possesses administration rights on a global directory subtree under/ . . . /<domain-name>/fs and is able to operate own servers.
   The method devised by the invention is however independent of the actual GFNS being used.

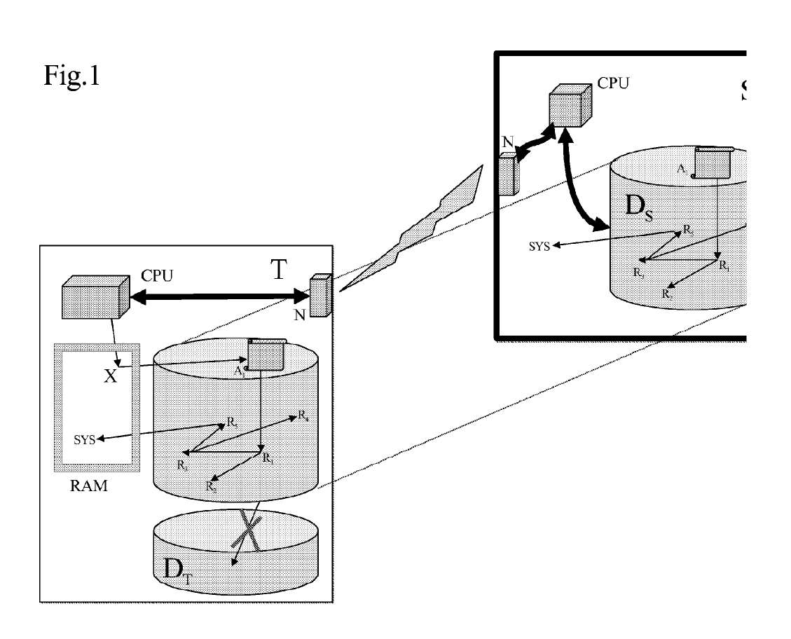

FIG. 1 illustrates a system according to the invention, for a case when GFNS is implemented via a server and a network connection. A server, S, comprising storage unit Ds, CPU and Interface N, communicates with at least one Terminal T comprising storage unit Dt, processing unit CPU and a memory unit, such as Random Access memory RAM, or any other reprogrammable memory unit.

The storage unit Ds stores GFNS which is the same at the server and the terminal as mentioned earlier.

The processing unit CPU of the terminal T is executing command sequence X from the memory unit RAM. The command sequence contains a reference to an application program file A1 which in this example is located in GFNS and hence is loaded into RAM via the network interfaces N-N from the server storage unit Ds. The application program present in A1 when loaded into RAM in turn refers to files containing some resources Rn (e.g. other application programs, shared libraries, wordlists or other kinds of data) which may in turn refer to other resources in the same GFNS or to the local operating system kernel SYS but for the chosen class of dependencies are ensured not to refer to file names located outside the GFNS, e.g. local files on the terminal data storage Dt.

Note that the application program A1 does not have to be loaded from GFNS, but making it available via GFNS makes it usable as a resource for other programs for the purposes of the present invention.

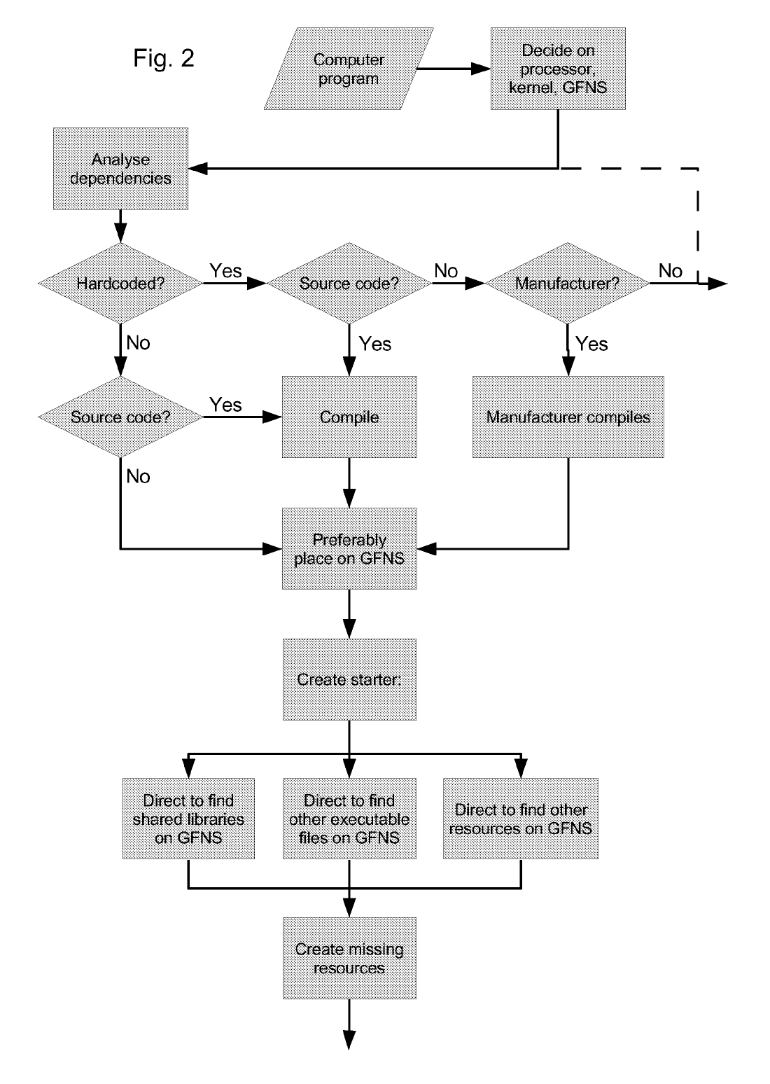

Thus, the process of configuration of a computer program (referred to as target program) comprises the following steps (FIG. 2):
1. Decide upon a suitable class of compatible processor types and a suitable class of compatible operating system kernels, depending on the hardware and the operating system of the computers considered to run the program.
2. Decide upon a suitable GFNS, e.g. use DFS as outlined above. Set up server computers, in a way specific to the chosen GFNS, to exercise control of data in the chosen GFNS, if said control is not available via other means or server computers provided by third parties.
3. Find out the dependencies of the target program on file objects (including file directories). This can be accomplished by well known methods, e.g. one or several of the following:
   using the target program's documentation;
   studying the target program's source code if available;
   using tools for dependency analysis, like “Idd” for shared libraries in Unix-like environments;
   studying the target program behaviour by
      running it and taking into consideration any diagnostic messages about resources being used or missing or/and
      running it with tracing tools like “strace” or “truss” in Unix-like environments, looking for file access operations;
   using other non-specific tools like “strings” in Unix-like environments for detection of file-name-like patterns in the program code;
   other suitable means.
4. Analyse the found dependencies, exclude from further consideration dependencies on
   resources with by definition known contents, like “/dev/null” in Unix-like environments;
   resources with a fundamental connection to the actual instance of said computer arrangement, like, in Unix-like environments, “/dev/audio” referring to the hardware, “/bin/su” providing extra privileges on the actual computer, “/proc” referring to the actual instance of the operating system kernel and the actual state of the computer memory unit;
   objects to be modified by the target program, like temporary files or text files to be edited;
   objects which an administrative entity initiating an instance of execution of the target program is normally expected to possess modification privileges for, like files and directories beneath the actual user's home directory.
5. Optionally exclude from further consideration dependencies which can be allowed to fail to be resolved properly (i.e. encounter either missing resource file, or a resource file with unexpected contents) without substantial impact on the target program's functionality, a possible example of such dependency being optional data sets unnecessary for the planned usage of the target program. Depending on the actual target program and its dependencies, this step may decide whether the present invention is applicable or practical in the actual case.
6. If the set of dependencies to consider is now empty, then the present invention is not applicable to the actual target program. In practice, vast majority of programs do contain further dependencies, which is the cause of the complexity of software administration.
7. If said set of dependencies contains constant (compiled-in) file names of resources, which do not belong to the chosen GFNS (or possibly point to unsuitable resources in said GFNS) and can not be overridden by run-time configuration, proceed as follows:
   If the target program is available in form of source code, then
      for each said name in said set of dependencies
         choose a location in said GFNS where either the needed resource is present or you possess sufficient privileges to create the resource at the chosen location
         make corresponding appropriate modifications to the source code or/and to the compilation process, to point to the chosen location.

If the target program is available in binary form only, let the program manufacturer make this step for you. If the manufacturer is not available or not cooperating, consider reapplying step 5 with reduced functionality requirements. If that is not practical, then the present invention is not applicable to the actual target program.
8. For each resource file name which is configurable at run-time in the said set of dependencies, apply an appropriate configuration technique or techniques, including but not limited to
   creation of a starter program, without dependencies on objects outside said GFNS, which initiates execution of the target program, having appropriately modified environment variables, command line arguments and/or alike so that the target program is directed to resolve its dependencies from suitable locations in GNFS, chosen in the way described in step 7; there are many well known applicable methods to direct the target program, depending on the actual operating system kernel class, including but not limited to
      environment variable LD_LIBRARY_PATH to instruct a program to look for shared libraries at certain locations;
      environment variable PATH to instruct a program to look for executable files at certain locations;
      program-specific environment variables, supplying the location of program-specific configuration files or other resources;
   for the best results, place the starter program itself in GNFS;
   preparation of a configuration file, possibly specific to the target program, placed in GNFS at a location chosen in the way described in step 7, said configuration file being used by the target program and directing it to resolve said program's dependencies from suitable locations in GNFS, chosen in the way described in step 7.
9. Create the possibly missing resources at the locations chosen as described above in said GFNS or ensure in some other way that the said resources will be present at the time of the target program's execution. This is the step where the advantage of the present invention is being used: due to the special properties of GFNS, to provide the necessary resources you do not have to access the computers going to run the program, nor to govern said computers' interaction with the network or media containing the resources.
10. Start of an application program configured according to this method can be done via full path to the file containing the program or the corresponding starter program when applicable, e.g. / . . . /example.com/fs/exampleapp.

1. A method in a computer arrangement comprising:
a processor and a memory unit, said processor being operatively arranged to execute instructions present in the memory unit, said memory unit including a specific isolated aggregate of instructions which through interaction with hardware provides function of access to data organized into named files, said processor being operatively arranged to execute a group of instructions including essential dependencies on resources represented by said data in form of named files other than
resources with by definition known contents,
resources with a fundamental connection to the actual instance of said computer arrangement,
objects to be modified by said group of instructions,
objects for which an administrative entity initiating an instance of execution of said instruction group is normally expected to possess creation or modification privileges,
to prepare said group of instructions for execution on said computer arrangement, wherein the method includes configuration of said group of instructions so that all said dependencies, with said exceptions, are directed to be resolved from a specific set of file names, said set consisting of one or several subsets, each of said subsets having the property that there is a primary standard way of connecting a computer arrangement to hardware units or other computer arrangements including data objects of said file name subset and that said names, used in said subset for the purpose of said resource reference, given access privileges and accounting for possible delays of updates' spreading, correspond to the same contents of referenced objects on all computer arrangements connected to said file name subset in said primary standard way.

2. The method of claim 1, wherein said set of file names comprising a directory tree or several of them.

3. The method of claim 2, wherein said directory tree being implemented by either interconnection of the apparatus by a network, or by other hardware, such as portable memory units.

4. The method according to claim 1, wherein said essential dependencies being directed to be resolved from objects, for which the administrative entity carrying out the configuration possesses modification privileges.

5. The method according to claim 1, further including loading of said instruction group into memory unit from one or several named files and placement of the files, including said instruction group, within the specified file name set.

6. A computer arrangement comprising:
a processor, a memory unit and means for interaction with other hardware units, said processor being operatively arranged to execute instructions present in the memory unit, said memory unit including a specific isolated aggregate of instructions which through interaction with hardware provides function of access to data organized into named files, said processor being operatively arranged to execute a group of instructions including essential dependencies on resources represented by said data in form of named files other than
resources with by definition known contents,
resources with a fundamental connection to the actual instance of said computer arrangement,
objects to be modified by said group of instructions,
objects for which an administrative entity initiating an instance of execution of said instruction group is normally expected to possess creation or modification privileges,
wherein said processor being operatively arranged to process and resolve said dependencies by configuring said instruction group so that all said dependencies, with said exceptions, are directed to be resolved from a specific set of file names, said set consisting of one or several subsets, each of said subsets having the property that there is a primary standard way of connecting a computer arrangement to hardware units or other computer arrangements including data objects of said file name subset and that said names, used in said subset for the purpose of said resource reference, given access privileges and accounting for possible delays of updates' spreading, correspond to the same contents of referenced objects on all computer arrangements connected to said file name subset in said primary standard way.

7. The computer arrangement according to claim 6, further including loading of said instruction group into memory unit from one or several named files and placement of the files, including said instruction group, within the specified file name set.

8. The computer arrangement according to claim 6, further including being connected over a network to one or more other computer arrangements including authoritative data corresponding to said specific set of file names
